(19) United States
(12) Patent Application Publication
(10) Pub. No.: US 2021/0012645 A1
(43) Pub. Date: Jan. 14, 2021

(54) SECURITY DEVICE AND METHODS

(71) Applicant: Leveland Brown, West Warwick, RI (US)

(72) Inventor: Leveland Brown, West Warwick, RI (US)

(21) Appl. No.: 16/899,769

(22) Filed: Jun. 12, 2020

Related U.S. Application Data
(60) Provisional application No. 62/872,795, filed on Jul. 11, 2019.

(51) Int. Cl. G08B 25/01; G08B 25/10; H04W 4/021; H04W 4/029; G06F 1/16

(52) U.S. Cl. CPC G08B 25/016; G08B 25/10; G06F 1/163; H04W 4/029; H04W 4/021

(57) ABSTRACT

A security system has a monitoring device configured to receive a wireless signal and a wearable device having a processor and a GPS tracking system configured to detect a GPS location of the wearable device. The wireless communication system, responsive to the processor identifying the wearable device is one of inside a predefined range of the monitoring device or outside a predefined range of the monitoring device, emits a wireless signal identifying the GPS location to the monitoring device. The wireless signal includes information regarding the user of the wearable device.

### CROSS-REFERENCE TO RELATED APPLICATIONS

This application is a utility conversion of and claims priority to U.S. Provisional Application No. 62/872,795, filed on Jul. 11, 2019 and entitled “Security Device and Methods,” the entire disclosure of which is hereby incorporated by reference for all proper purposes.

### FIELD

This invention is related to security. Specifically, but not intended to limit the invention, embodiments of the invention are related to home security methods.

### BACKGROUND

A number of security devices are known. There remains a need, however, for quickly identifying service personnel approaching a home or the location of missing vulnerable persons and/or other new and innovative systems.

### SUMMARY

An exemplary security system has a monitoring device configured to receive a wireless signal. The system has a wearable device having a processor and a GPS tracking system configured to detect a GPS location of the wearable device, a user interface, and a wireless communication system. The wireless communication system, responsive to the processor identifying the wearable device is one of inside a predefined range of the monitoring device or outside a predefined range of the monitoring device, is configured to emit a wireless signal identifying the GPS location to the monitoring device. The wireless signal includes information regarding the user of the wearable device.

### BRIEF DESCRIPTION ON THE DRAWINGS

FIG. 1 is a schematic of an exemplary security system; and

FIG. 2 is a schematic of another exemplary security system.

### DETAILED DESCRIPTION

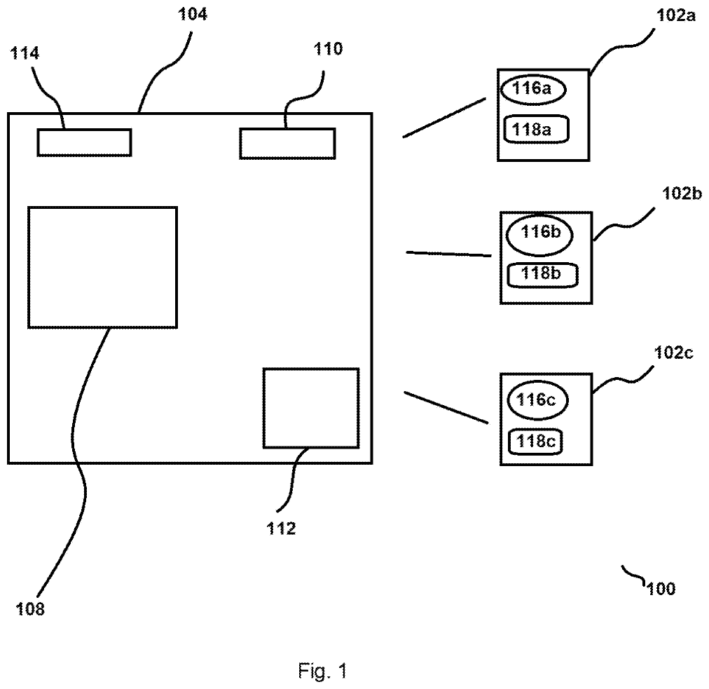

As illustrated in FIG. 1, in some embodiments, a security system 100 may be provided and configured to identify employees of a company providing an in-home service or home delivery service, such as food delivery personnel, home repair service providers, home cleaning service providers, and more. This system 100 may include a first device 102a, 102b, 102c, which may be a wearable device such as, but not limited to, a bracelet or necklace, that is configured to send a signal through the resident's internet or cable television system 110 via any wireless communication means known. In some embodiments, the television system 110 is a cable system 110 and is configured to verify that the person making the delivery or providing the home service actually works for that particular company, such as, for example, by communicating with the particular company via wireless internet 114.

In some embodiments, the employee-worn device is configured to send out the signal to the tv or cable within 200 to 300 feet of the employee's destination or home.

In some embodiments, the tv cable box or internet or cable television system 110 is configured to ring like a doorbell or emit an audible signal upon receiving the signal from the user-worn device. In some embodiments the cable tv box system 110 is configured to display on the tv at least one of: the employee's business ID, photo, or phone number.

In some embodiments, after the employee has finished his or her transaction, the customer or homeowner will then be able to give feedback as to how the service was. That is, the cable tv box or television system 110 may be configured with a homeowner or user interface 112 and may receive input from the user or homeowner. The cable tv box or system 110 may be configured to share the homeowner feedback with the employer of the service provider.

In some embodiments, the security system 100 has a monitoring device 104 configured to receive a wireless signal, a wearable device 102a, 102b, 102c having a processor and a GPS tracking system configured to detect a GPS location of the wearable device 102a, 102b, 102c, a user interface 116a, 116b, 116c, and a wireless communication system 118a, 118b, 118c. The wireless communication system 118a, 118b, 118c, responsive to the processor identifying the wearable device 102a, 102b, 102c is inside a predefined range of the monitoring device 104, may be configured to emit a wireless signal identifying the GPS location to the monitoring device 104. The wireless signal may include information regarding the user of the wearable device 102a, 102b, 102c.

The monitoring device 104 may be configured to display identifying information regarding the user of the wearable device 102a, 102b, 102c on a screen 208. The monitoring device 104 may be a television having a cable connection or an internet connection. The monitoring device 104 may be configured to display identifying information in response to receiving a wireless signal from the wearable device 102a, 102b, 102c.

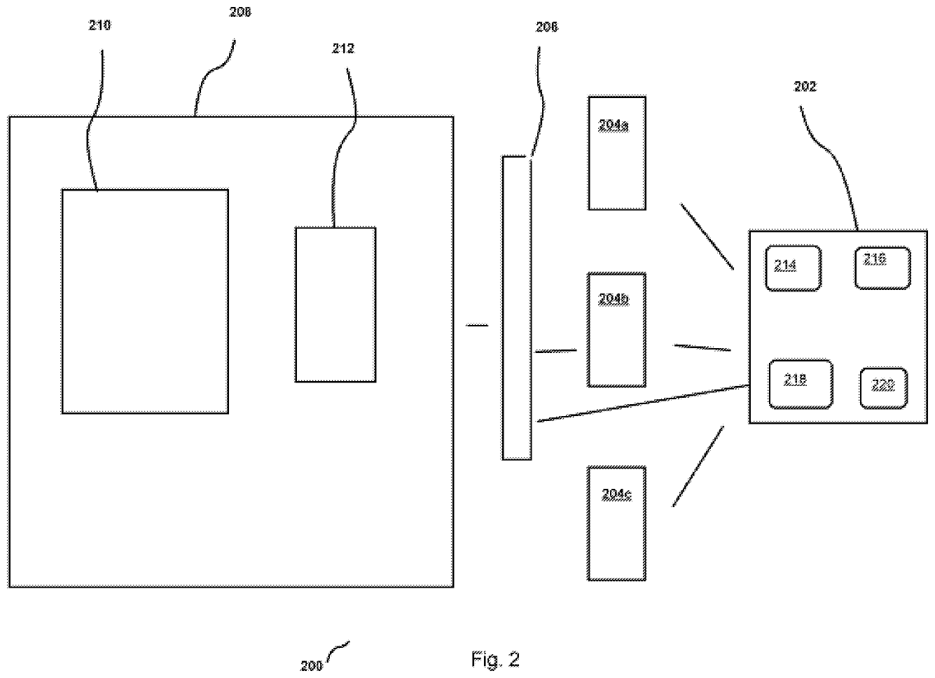

With reference now to FIG. 2, in some embodiments, the security system 200 may include a voice activated GPS system worn by a first user. This first user may be an elder or disabled person, a child, or any other person requiring particular care or monitoring. In some embodiments, the GPS system may be activated by the first user saying a pre-programed phrase. In some embodiments, the GPS system may be activated when the first user is greater than a preset distance from a home alarm system or a second user's cell phone.

In some embodiments, the device worn by the first user is configured to send an alarm signal to the first user's custodian, such as a parent, legal guardian, and/or caregiver. In some embodiments, the device worn by the first user is configured to send a signal to one or more home tv cable boxes within a pre-defined radius of the first user, such as within 200 feet, or such as within 500 feet, or such as within 1000 feet of the first device. In some embodiments, the device worn by the first user is configured to send a signal to one or more mobile phones within a pre-defined radius of the first user, such as within 200 feet, or such as within 500 fee, or such as within 1000 feet of the first device. In some embodiments, law enforcement may be notified.

When that signal is received by the cable box or mobile phone, the cable tv box or mobile phone may display one or more of the first user's photo ID, personal information such as height, weight, hair color, eye color, or the contact name and/or phone number of the custodian or an emergency contact.

In some embodiments, if the house is equipped with a video doorbell, the first user's device and/or the cable tv box may be configured to turn the video doorbell on to record the surrounding area.

In some embodiments, the first user's device is configured with a GPS and signal that will follow the first user from house to house, thereby giving the custodian and/or law enforcement personnel the direction that the first user is traveling in.

In some embodiments, a security system 200 has a monitoring device 208 configured to receive a wireless signal, and a wearable device 202 having a processor 214 and a GPS tracking system 216 configured to detect a GPS location of the wearable device 202, a user interface 218, and a wireless communication system 220. The wireless communication system 220, responsive to an input to the user interface 218, is configured to emit a wireless signal identifying the GPS location to the monitoring device 208. The wireless communication system 220, responsive to the processor 214 determining the wearable device 202 is outside a predefined range of the monitoring device 208, may be configured to emit a wireless signal identifying the GPS location to the monitoring device 208. The wireless signal may include identifying information regarding the user of the wearable device 202, such as age, height, a photograph, emergency contact, etc. The identifying information 212 may be displayed on the monitoring device 208. The monitoring device 208 may be configured to display the identifying information regarding the user of the wearable device on a screen 210. The wireless signal may include a communication to a cable service provider 206, whereby the wireless signal is converted to a wire signal to the monitoring device 202. In some embodiments, the wearable device 202 is configured to signal a plurality of cellular phones 204a, 204b, 204c within a predefined radius when the wearable device 202 is outside the predefined range.

In some embodiments, the information regarding the user comprises employment information, such as a service provider.

In some embodiments, the wireless communication system, responsive to the processor identifying the wearable device is outside a predefined range of the monitoring device, is configured to emit a wireless signal identifying the GPS location to the monitoring device, the monitoring device having a first television having a first service account. The wireless communication system may be configured to emit a wireless signal identifying the GPS location to a second television having a second service account different from the first service account.

The first service account may be serviced by a first television service provider, and the second service account may be serviced by a second television service provider different from the first television service provider.

The wireless communication system, responsive to the processor identifying the wearable device is outside the predefined range of the monitoring device, may be configured to emit a wireless signal identifying the GPS location to law enforcement.

Each of the various elements disclosed herein may be achieved in a variety of manners. This disclosure should be understood to encompass each such variation, be it a variation of an embodiment of any apparatus embodiment, a method or process embodiment, or even merely a variation of any element of these. Particularly, it should be understood that the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled.

As but one example, it should be understood that all action may be expressed as a means for taking that action or as an element which causes that action. Similarly, each physical element disclosed should be understood to encompass a disclosure of the action which that physical element facilitates. Regarding this last aspect, the disclosure of a “monitoring device” should be understood to encompass disclosure of the act of “monitoring”—whether explicitly discussed or not—and, conversely, were there only disclosure of the act of “sending”, such a disclosure should be understood to encompass disclosure of a “sending mechanism”. Such changes and alternative terms are to be understood to be explicitly included in the description.

Moreover, the claims shall be construed such that a claim that recites “at least one of A, B, or C” shall read on a device that requires “A” only. The claim shall also read on a device that requires “B” only. The claim shall also read on a device that requires “C” only.

Similarly, the claim shall also read on a device that requires “A+B”. The claim shall also read on a device that requires “A+B+C”, and so forth.

The claims shall also be construed such that any relational language (e.g. perpendicular, straight, parallel, flat, etc.) is understood to include the recitation “within a reasonable manufacturing tolerance at the time the device is manufactured or at the time of the invention, whichever manufacturing tolerance is greater”.

Those skilled in the art can readily recognize that numerous variations and substitutions may be made in the invention, its use and its configuration to achieve substantially the same results as achieved by the embodiments described herein.

Accordingly, there is no intention to limit the invention to the disclosed exemplary forms. Many variations, modifications and alternative constructions fall within the scope and spirit of the invention as expressed in the claims.

What is claimed is:

1. A security system, comprising:
a monitoring device configured to receive a wireless signal;
a wearable device having a processor and a GPS tracking system configured to detect a GPS location of the wearable device, a user interface, and a wireless communication system; wherein
the wireless communication system, responsive to the processor identifying the wearable device is one of inside a predefined range of the monitoring device or outside a predefined range of the monitoring device, is configured to emit a wireless signal identifying the GPS location to the monitoring device; and further wherein
the wireless signal includes information regarding the user of the wearable device.

2. The security system of claim 1, wherein:
the monitoring device is configured to display identifying information regarding the user of the wearable device.

3. The security system of claim 1, wherein:
the information regarding the user comprises employment information.

4. The security system of claim 1, wherein:
the monitoring device is a television having a cable connection.

5. The security system of claim 1, wherein:
the wireless communication system, responsive to the processor identifying the wearable device is outside the predefined range of the monitoring device, is configured to emit a wireless signal identifying the GPS location to the monitoring device, the monitoring device having a first television having a first service account; and wherein
the wireless communication system, responsive to the processor identifying the wearable device is outside the predefined range of the monitoring device, is configured to emit a wireless signal identifying the GPS location to a second television having a second service account different from the first service account.

6. The security system of claim 5, wherein:
the first service account is serviced by a first television service provider; and
the second service account is serviced by a second television service provider different from the first television service provider.

7. The security system of claim 6, wherein:
the wireless communication system, responsive to the processor identifying the wearable device is outside the predefined range of the monitoring device, is configured to emit a wireless signal identifying the GPS location to law enforcement.

8. The security system of claim 7, wherein:
the wireless signal includes information regarding the user of the wearable device.
